(19) United States
(12) Patent Application Publication
(10) Pub. No.: US 2021/0150213 A1
(43) Pub. Date: May 20, 2021

(54) METHOD FOR RECOGNITION OF AN OCCUPANCY SITUATION OF A FURNITURE, A DEVICE, A FURNITURE SYSTEM AND A RESERVATION SYSTEM

(71) Applicant: Kesseböhmer Produktions GmbH & Co. KG, Weilheim/Teck (DE)

(72) Inventor: Melf HANSEN, Gondelsheim (DE)

(73) Assignee: Kesseböhmer Produktions GmbH & Co. KG, Weilheim/Teck (DE)

(21) Appl. No.: 17/045,173

(22) PCT Filed: Mar. 19, 2019
(86) PCT No.: PCT/EP2019/056793

§ 371 Date: Oct. 4, 2020

(30) Foreign Application Priority Data
Apr. 5, 2018 (DE) 10 2018 205 158.5

(51) Int. Cl. G06K 9/00; A47B 21/02; A47B 9/00; G06Q 10/02

(52) U.S. Cl. CPC G06K 9/00671; A47B 21/02; A47B 2200/0062; G06Q 10/02; A47B 9/00

(57) ABSTRACT

A method for recognition of an occupancy situation of a furniture comprising monitoring a sensor signal which corresponds to a force effect on the furniture when the furniture is occupied and releasing the furniture and changing the state of the occupancy situation from Occupied to Released when the force effect is below a threshold during an entire predetermined period.

The present application claims priority under 35 U.S.C. § 365 to PCT/EP2019/056793 filed on Mar. 19, 2019, which the benefit of DE Application No. 102018205158.5 filed Apr. 5, 2018, the disclosure of which is incorporated herein by reference.

The present invention relates to a method for recognition of an occupancy situation of a furniture, to a device, to a furniture system and to a reservation system.

In the modern and flexible working environment, open-plan offices become increasingly popular. In such an open-plan office, no determined workplace is available for an employee of a company. Instead, the employee either selects an arbitrary vacant workplace or such a workplace is assigned to him when he wants to work in the open-plan office.

Here, the problem exists that an employee could reach the open-plan office at a time when all workplaces are occupied and, therefore, no vacant workplace is available. In order to solve this problem, reservation systems are known in the state-of-the-art. By means of such a reservation system, an employee can book (or reserve) a workplace, e.g., the day before, whereby the workplace is available for sure at the requested time.

When using such reservation systems, it has to be considered that all workplaces indeed can be occupied or reserved at a certain time, however, some of these reservations are not adopted so that some workplaces remain vacant despite reservation. Hereby, actual vacant capacities are not used. Furthermore, a problem arises if an employee does not release the workplace when finally leaving the workplace, therefore after his individual finishing time. Also hereby, actual vacant capacities remain unused.

For solving this problem, the provision of presence sensors at the workplaces are known in the state-of-the-art. These presence sensors are usually configured as motion sensor for example being attached below a tabletop of the workplace. By the motion sensor, a workplace can automatically be released if no motion is registered for a certain period.

The provision of a motion sensor at every workplace is expensive and lavish. Moreover, a problem arises to the effect that the motion sensor indeed registers motions at a workplace, for example by passing persons, however, the workplace is not (still) used anyway and, therefore, could/should rather be released.

Furthermore, in the state-of-the-art, constructions of height-adjustable furniture on which a collision sensor is arranged in the force action chain between a fixed part of furniture standing on the floor and a movable part of the furniture are known. Such constructions are, for example, known by the specification for patent EP 2 583 586 Bl.

When using electrically adjustable furniture, there is the risk that an adjustable part of the furniture collides with an obstacle during the electrical adjustment. When using electrically height-adjustable desks, a sensor which recognizes collisions of the movable part, here, e.g., the tabletop, with obstacles during the height-adjustment can for example be provided in the force action chain between tabletop and table column standing on the floor. Such a collision sensor can be a force sensor provided between the tabletop and the adjustable part of the table column. Alternatively hereto, such a sensor can also be a part of the electric motor of the table column.

For controlling height-adjustable furniture (e.g., for lifting or lowering a height-adjustable tabletop), operating elements to be operated by the finger are usually provided. From the published patent application DE 10 2014 221 265 A1, controlling of a height-adjustable furniture by evaluating sensor signals of an above-mentioned collision sensor without being forced to provide an operating element to be operated by the finger is known alternatively thereto.

From the state-of-the-art, furthermore, car parks having systems which recognize an occupied parking place and indicate by means of green or red arrows to a driver who searches a parking place in which region of the car park a vacant parking place can be found.

For achieving at least one of the above problems, a method, a device, a furniture system and a reservation system according to the independent claims are provided.

Advantageous further developments are subject-matter of the dependent claims.

According to at least one embodiment of the invention, a sensor provided and/or suitable for recognition of collisions of an adjustable part of a furniture with obstacles is monitored in an idle state of the furniture. Hereby, the idle state is a state in which no adjustment procedure of the adjustable furniture takes place. In the state-of-the-art, these sensors are monitored merely during the adjustment procedure of the adjustable furniture, therefore, out of the idle state.

For example, a collision sensor can be a force sensor (FSR) which changes its conductance value upon loading, a Piezo sensor, a strain gauge (DMS), or also a press key. According to at least one embodiment of the invention, other suitable types of sensors can also be deployed.

The above inventive idea is not restricted to adjustable furniture. Preferably, the sensor is arranged in the force action chain between arbitrary parts of a furniture such that sensor signals are generated during the use of the furniture by a user.

For example, a sensor being arranged in the force action chain between a tabletop and a table column standing on the floor of either a height-adjustable desk or the non-height-adjustable desk is monitored in an idle state of the furniture.

Also referring to non-adjustable furniture, in the context of this application text, such a sensor is denominated as collision sensor.

Furthermore, desks are referred to in this application text for illustration. A desk is an example of a furniture. There are height-adjustable desks and non-height-adjustable desks. However, the inventive idea is not restricted to desks. In fact, the invention also can generally be used for furniture to which a force acts or an exerted force is changed in an arbitrary manner during a use by a user.

If, for example, a desk is used for working, then, in regular periods, the employee will support himself on the tabletop, put objects onto the tabletop or remove them therefrom, etc. Thus, during working, therefore, in a state in which the desk is actually occupied and used by an employee, a modification of the sensor signal can be detected.

Preferably, signals of the sensors provided for detecting collisions of an adjustable part of a furniture with obstacles and/or being suitable therefore are used for determining the occupancy situation of the furniture. Preferably, also sensors not being arranged in adjustable furniture are used.

When using adjustable furniture, the same sensor which is also used for detecting collisions with obstacles during the adjustment is preferably used for determining the occupancy situation of the furniture.

When using adjustable furniture, signals of the at least one sensor provided for detecting collisions are preferably used. However, alternatively or additionally thereto, the signal of a sensor which is arranged in a force action chain between different parts of the furniture in a suitable manner but which is not used for detecting collisions can also be used.

When using a height-adjustable desk having for example two adjustable table columns, a sensor can respectively be arranged in the force action chain between the tabletop and each of the table columns. Thereby, one of the sensors can merely be used for collision detection and the other of the sensors merely for occupancy detection.

The inventive idea aims preferably thereto that, by a suitable arrangement of a sensor in the force action chain between different parts of a furniture, the provision of a motion sensor can be waived. Hereby, amongst others, a detection of the occupancy state is achieved with lower error-proneness. Furthermore, among others, a cost advantage is achieved during the manufacturing since the provision of a motion sensor can be waived by an evaluation of signals of present sensors. However, even then, if an additional suitable sensor has to be provided instead of a motion sensor, a cost advantage will be achieved.

Generally expressed, by the configuration according to at least one embodiment of the invention, the provision of a motion sensor can be waived. Hereby, the entire construction becomes cheaper in the manufacturing and less error-prone in the daily use.

Subsequently, different occupancy situations of the furniture according to a method according to at least one embodiment of the invention are defined.

The occupancy situation of the furniture according to a method according to at least one embodiment of the invention comprises the state “Occupied”. This is a state in which the furniture (or the workplace) is actually used by an employee. Furthermore, the state “Occupied” is a state in which the employee departs from the furniture for a short time (for example when going to the coffee machine/sanitary equipment), however, uses it again after his return. Optionally, the state “Occupied” is also a state in which the employee departs from his workplace for a longer time (for example, during the lunchtime), however, is further working after his return.

Therefore, the state “Occupied” is a state in which the furniture is currently justifiably assigned to a defined employee and shall not be available for another employee. Contrary to that, the state “Occupied” is not mandatorily a state in which the employee is actually sitting at the desk.

The occupancy situation of the furniture according to a method of at least one embodiment of the invention comprises the state “Released”. This is a state in which the furniture is currently not assigned to an employee and, therefore, shall be available for an arbitrary employee if necessary.

The occupancy of the furniture according to a method of at least one embodiment of the invention comprises the state “Reserved”. This is a state in which, at a current time, the furniture is scheduled for the use by a defined employee. Therefore, if a reservation of a defined furniture for tomorrow is done today, then, the furniture is not (yet) in the state “Reserved” today although the furniture is reserved for tomorrow. The occupancy situation of the furniture is denominated “Reserved” not before the current time is within the reserved period.

Preferably, the monitoring of the sensor signal in the idle state of the furniture is started not before the furniture is in the occupancy state “Reserved”. Hereby, the monitoring is merely executed then when recognition of the occupancy situations “Released” and “Occupied” is advantageous. In the remaining period, energy is saved.

Preferably, the method of at least one embodiment of the invention is executed by means of a device provided for one single furniture.

Alternatively, the method of at least one embodiment of the invention is preferably executed by means of a device provided for an arbitrary number of furniture.

Preferably, a reservation system configured for the communication with users of furniture is provided so that these users can reserve a furniture (or a workplace) for a requested period.

Preferably, the monitoring of the sensor signal in the time off work, for example, on holidays, is deactivated. Hereby, energy can be saved.

Preferably, the course of the sensor signal is stored in order to evaluate working processes based on thereon.

Preferably, the course of the sensor signal is stored, in order to evaluate the load of the furniture based thereon.

According to at least one embodiment of the invention, a device for recognizing an occupancy situation of at least one furniture (wherein the furniture comprises a part which is acted on by a user during a use), comprising a collision sensor arranged in the force action chain between this part and the residual furniture. The device is further configured to execute a method of at least one embodiment of the invention.

The component of the furniture which is acted on by a user during use of the furniture is, for example, a tabletop of a desk. A user supports himself on this tabletop when working, lies his arms/hands and objects onto the tabletop and remove them from the tabletop again. In this manner, the user acts to the tabletop in this case.

The device preferably comprises a communication device for data transmission.

Preferably, one device is provided for each piece of furniture, or one device is provided for several pieces of furniture.

Furthermore, the invention can also be used in gastronomy. For example, for detecting the occupancy state of vacant tables in a restaurant.

A system of at least one piece of furniture and at least one device according to at least one embodiment of the invention is defined as a furniture system.

Preferably, this furniture system comprises a guide device. This guide device can comprise a plurality of optical indicating elements. Preferably, the guide device is configured to indicate the route to a vacant furniture to a user searching for a vacant furniture or to guide the user to the vacant furniture. This happens analogously to known guiding systems in car parks.

If, for example, a guest is searching for a vacant table (i.e., furniture) in a restaurant, the guest is guided to a vacant table preferably by the guide device. This can be done by indicator devices within the restaurant. If a restaurant comprises turning options for a guest walking through the seating area (for example, one passageway leads to the left and one passageway leads to the right) within the seating area, an indicator device is arranged at each turning option. Hereby, the guest can be guided to a vacant table.

As a further development, instead of or additionally to the guiding devices, the guide device can be configured to communicate with augmented reality glasses. Such glasses of the manufacturer Google® is for example known as Google Glass®. According to this further development, the guide device is configured to guide a user using such glasses the way to a vacant furniture. This happens by means of optical instructions which are provided to the user by the augmented reality function.

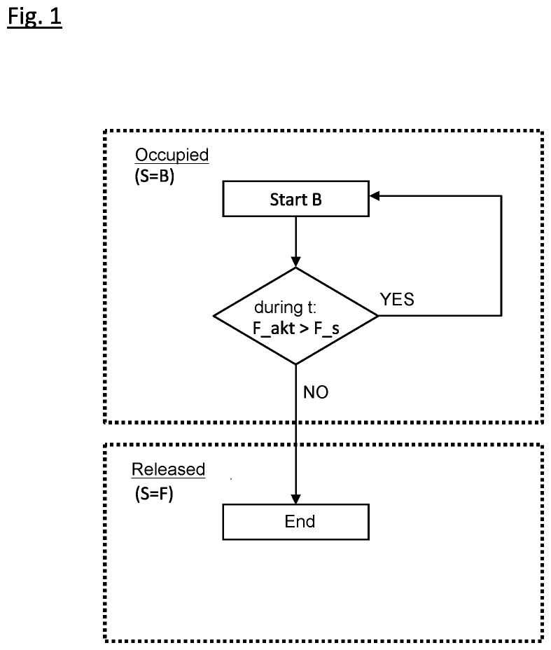

FIG. 1 shows a method according to the invention in a first embodiment.

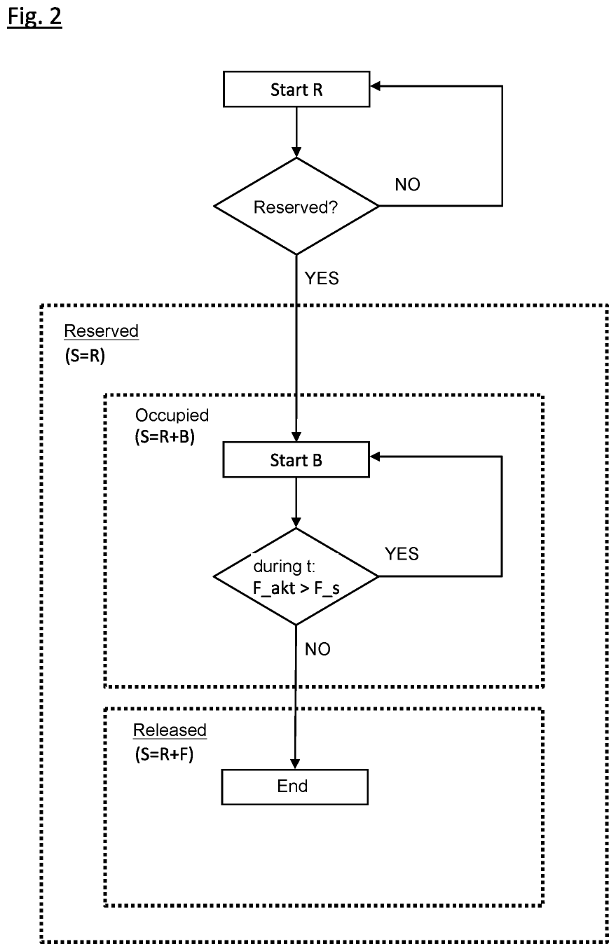

FIG. 2 shows a method according to the invention in a second embodiment.

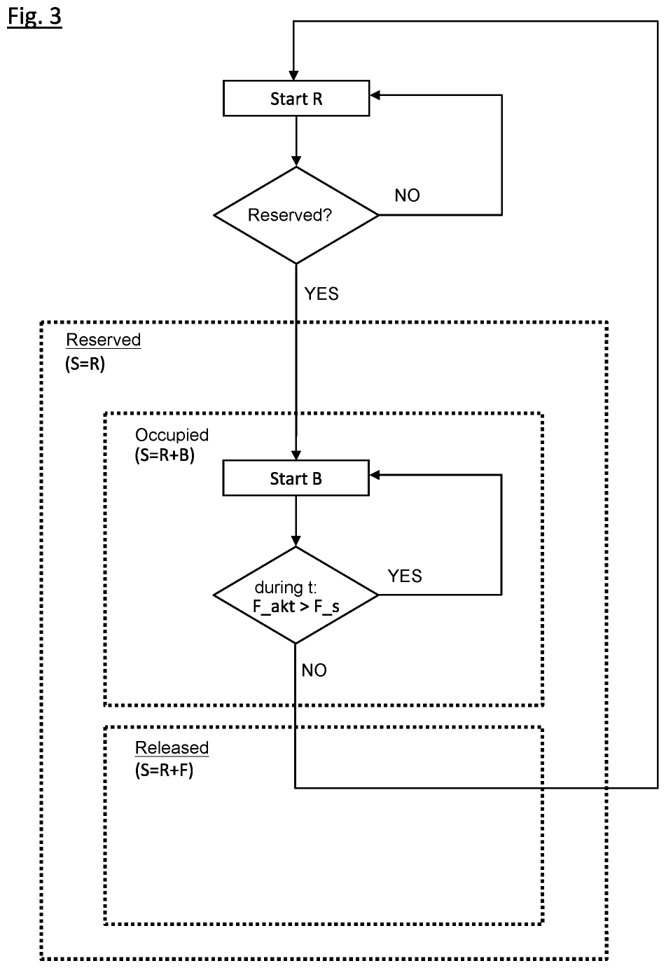

FIG. 3 shows a method according to the invention in a third embodiment.

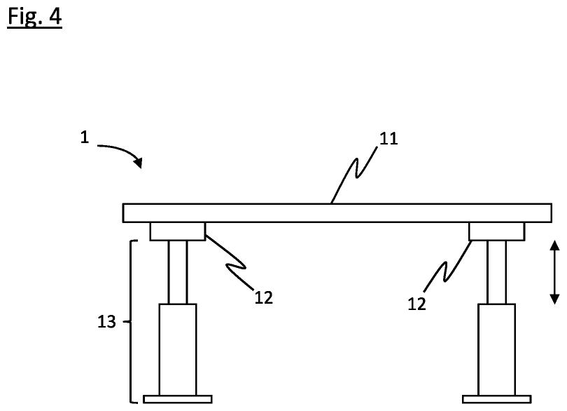

FIG. 4 shows a height-adjustable desk according to the state of the art.

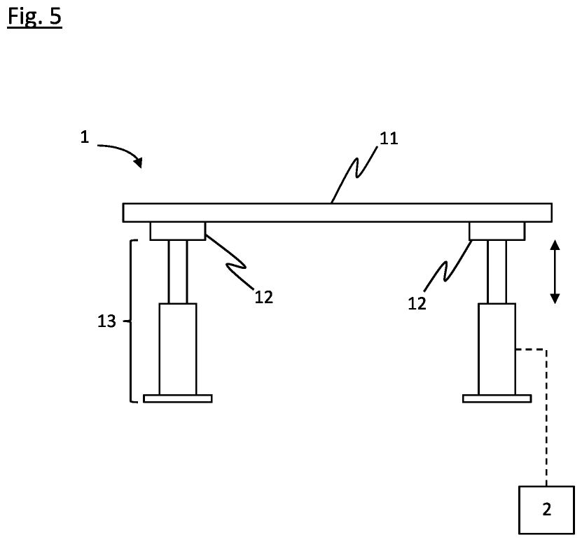

FIG. 5 shows a height-adjustable desk having a device according to at least one embodiment of the invention.

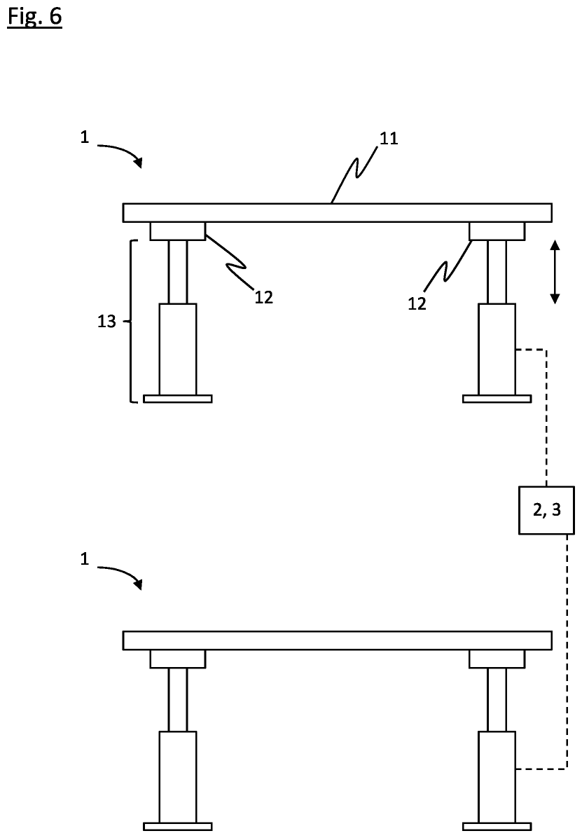

FIG. 6 shows two height-adjustable desks having one device according to at least one embodiment of the invention.

FIG. 1 shows a flowchart of a method according to the invention in a first embodiment.

This method is provided for recognizing an occupation situation of an adjustable furniture. This adjustable furniture can be, for example, a height-adjustable desk in an open-plan office. However, this method is not restricted to a height-adjustable desk in an open-plan office. Rather, the method can also be used for other adjustable and non-adjustable furniture.

The method according to the invention in the first embodiment starts at a starting point “Start B”. The starting point “Start B” is located within an area being arranged above in FIG. 1 and depicted in a dotted manner. This area describes an occupancy situation S corresponding to a state occupied B (S=B). In the subsequent step of the method, which is depicted by a rhombus, it is ascertained whether, at least in one case, a current force F_akt corresponding to a force effect on the furniture when the furniture is occupied is larger than a threshold force F_s determined beforehand.

For example, the period t corresponds to a period of 10 minutes and the threshold F_s determined before corresponds to a threshold of 5 Newton (which about corresponds to a weight force generated by a body with the mass of 0.5 kg). Starting from these exemplarily mentioned values, in this method step, it would be decided whether the current force F_akt is larger than the determined threshold F_s of 5 Newton at least in one case within the period of 10 minutes. If this condition is fulfilled, the method leads again to the starting point “Start B” without changing the occupancy situation S.

Preferably, the method leads again immediately to the starting point “Start B” as soon the current force F_akt is in one case larger than the determent threshold F_s in this step.

Preferably, the query within the rhombus (by which is ascertained whether a current force F_akt is larger than the threshold force F_s determined before at least in one case within a period t determined before) is not executed during pause times of an employee. Alternatively thereto, indeed, this query is preferably also executed during the pause times, however, independent from the current force F_akt, the occupation situation within these pause times is not changed to Released but remains at Occupied. Hereby, an employee can leave his desk in pause times and can return to the desk after the pause without the risk that the desk is occupied by another employee in the meantime.

Preferably, the employee has a predefined contingent of pause times per day for his individual disposal. This contingent can be, for example, 60 minutes. Preferably, the furniture has a further occupancy state “Pause” which corresponds to a sub-state of the occupancy state “Covered.” If an employee leaves his desk for, e.g., the lunchtime, he can set it to the occupancy situation Pause, whereby a release of the desk is prohibited. The setting of the occupancy situation Pause is possible repeatedly and as long as the contingent of pause time is consumed. For example, the employee can leave the desk for a lunchtime of 30 minutes as well as for two further pauses of 15 minutes (therefore, together the above-indicated contingent of 60 minutes) and can prohibit an automated release of the desk by the setting of the occupancy state Pause in this period. As soon the time contingent is consumed, preferably, the occupancy state Pause cannot be selected anymore.

According to at least one embodiment of the invention, the current force F_akt corresponds to a force corresponding to a force exertion onto a movable part of a furniture. For example, the current force F_akt corresponds to a force exertion onto the tabletop of a height-adjustable desk.

According to at least one embodiment of the invention, the current force F_akt is measured by means of sensors provided for detecting collisions of the movable part of the furniture with objects in the environment during the adjusting process. For example, the current force F_akt is measured by means of sensors provided for detecting collisions of a tabletop of a desk being height-adjustable in a motorized manner with objects in the environment during the adjusting process. Such a sensor is denoted as collision sensor.

Preferably, the current force F_akt in the starting point “Start B” is set to zero or reset. This is caused by the subsequently mentioned background. If a height-adjustable desk is not used, the collision sensor will anyway measure a current force F_akt larger than zero. This is because the weight of the tabletop including all of the objects being thereon bears down onto the collision sensor. Therefore, preferably, the scale of the current force F_akt is set to zero in the starting point “Start B”.

As soon as in the method according to at least one embodiment of the invention, it is decided that the current force F_akt is larger than the defined threshold F_s in one case, it is concluded therefrom that a user works at the height-adjustable desk.

Alternatively, in this method as well as in all subsequently described methods according to the invention, the current force F_akt is replaced by ΔF_akt, preferably by the magnitude of ΔF_akt. Hereby, changes of the force F_akt measured by the collision sensor are detected and serve as base for the decision for the method according to at least one embodiment of the invention. Therefore, it can be concluded that a user works at the height-adjustable desk also then when he removes an object from the tabletop and therefore releases the collision sensor.

In case that within the method step depicted in the rhombus, it is detected that, within the period t determined before, the current force F_akt has been larger than the threshold F_s determined before at no point of time, the method is terminated by the next method step “End” (endpoint). The endpoint lies within a dotted area illustrated below in the FIG. 1. This area describes an occupation situation S corresponding to a condition Released F (S=F).

FIG. 2 (second embodiment) shows a further development of the first embodiment of the method according to the invention illustrated in FIG. 1.

The second embodiment shows an extension of the first embodiment. The second embodiment shows a large dotted area. This area describes an occupancy situation S corresponding to a state Reserved R (S=R). The method illustrated within this area corresponds to the first embodiment of the method according to the invention known from FIG. 1 (optionally including the alternative and described above occupancy situation Pause). The area outside the large dotted area corresponds to an occupancy situation Released.

Above the area corresponding to the state Reserved R, the starting point (Start R) of the second embodiment is located. Starting from this starting point, it is checked whether the current point of time is within a period in which the height-adjustable desk is reserved. If the desk is reserved at the current point of time, the method known from FIG. 1 starts at the starting point “Start B”.

The state Occupied (S=B) and the state Released (S=F) from FIG. 1 are marked with the additional state R in FIG. 2 since this partial area of the method in the second embodiment is only executed when the state Reserved (S=R) is present. Thus, the state Occupied (S=B) also corresponds to the state Reserved (S=R), therefore, also to (S=R+B). Analogously, the state Released (S=F) also corresponds to the state Reserved (S=R), therefore, also (S=R+F).

By the second embodiment of the method, energy or current can be saved. Since the monitoring of the sensor signal (F_akt) of the collision sensor is only executed when the desk is also reserved at the current point of time. According to this embodiment, a user has to mandatorily reserve the writing desk when he wants to use it.

Alternatively to a mandatory reservation before the use, the state Reserved (and, therefore, Occupied) is automatically activated as soon as a vacant and not reserved desk is used by a user.

Preferably, starting from a release state, a use of a writing desk is detected by an operation of the height-adjusting function by the user. In case that, therefore, a desk is in the occupancy situation Released and a user operates a button provided for height adjustment on this desk, the desk is hereby preferably set into the state Reserved (and, thus, Occupied). Alternatively, another button, preferably also a fingerprint sensor, is provided on the writing desk.

The recognition if a writing desk is used starting from a release state can preferably also take place without the operation of a function by the user. Hereto, alternatively, also the sensor signal (F_akt) can be monitored and evaluated.

FIG. 3 (third embodiment) shows a further development of the second embodiment of the method according to the invention illustrated in FIG. 2.

The third embodiment differs from the second embodiment in that the endpoint of the second embodiment does not exist. In the third embodiment, the method is guided again to the starting point Start R instead of to the endpoint of the second embodiment.

FIG. 4 shows a height-adjustable desk according to the state-of-the-art. This desk serves as an example for a furniture 1, the occupancy situation of which is detected by the method according to at least one embodiment of the invention.

The writing desk comprises a tabletop 11 as well as height-adjustable table columns 13. In the force action chain between the tabletop 11 and the height-adjustable table columns 13, sensors 12 provided for detecting collisions of the tabletop 11 with obstacles during the height adjustment and stopping the height adjusting process upon such a collision immediately are arranged.

The method according to at least one embodiment of the invention preferably uses at least one sensor signal of the sensors 12 which corresponds to the sensor signal F_akt.

FIG. 5 shows the height-adjustable desk from FIG. 4, wherein a device 2 is connected to the desk. This device 2 is configured to execute the method according to at least one embodiment of the invention. The combination of the height-adjustable desk and the device 2 is denoted as furniture system.

According to the embodiment of FIG. 5, the device 2 is arranged separately from the desk. In a further embodiment (not shown here), the device 2 is integrated into the desk.

FIG. 6 shows several of the height-adjustable desks of FIG. 4, wherein these desks are respectively connected to the device 2, and the device 2 is configured to execute a method according to at least one embodiment of the invention for each of the desks.

A combination of several height-adjustable desks and one device 2 is also denoted as furniture system.

Furthermore, the device 2 is configured to also serve as a reservation system 3.

In the description of the figures, the inventive idea is exemplarily described by means of a height-adjustable desk. However, the described height-adjustable desk can be replaced arbitrarily by a general adjustable or non-adjustable furniture. Therefore, all features described by means of the height-adjustable desk are also disclosed generally for an adjustable or non-adjustable furniture.

Furthermore, the described height-adjustable desk can also be replaced by a working desk/a workbench (for example for assembly operations). Thus, all of the features which have been described by means of the height-adjustable desk are disclosed for a working desk/a workbench.

Furthermore, the invention can be deployed in an outstanding manner in libraries, for example, also in universities, in which the problem exists that few existing working places are reserved by students by storing writing tools and books although the writing desks are currently (and for several hours) not used.

Furthermore, the power supply of the device 2 and/or of the furniture 1 can take place by means of battery or accumulated technique.

1. A method for recognition of an occupancy situation of a furniture, wherein the occupancy situation comprises the states Occupied and Released, comprising:
monitoring a sensor signal which corresponds to a force effect on the furniture when the furniture is occupied; and
releasing the furniture and changing the state of the occupancy situation from Occupied to Released when the force effect is below a threshold during an entire predetermined period.

2. The method according to claim 1, wherein the force effect is
a force effect on a movable part of the furniture, or
a force effect on a part of the furniture which is acted on by a user when the furniture is used.

3. The method according to claim 1, wherein the sensor signal is a sensor signal that recognizes collisions of the movable part of the furniture with obstacles.

4. The method according to claim 1, wherein the furniture comprises at least one of a height-adjustable desk and a non-height-adjustable gastronomy table.

5. The method according to claim 1, wherein the occupancy situation comprises a further state Reserved, the method further comprising:
starting the monitoring of the sensor signal when a current time is within a period in which the furniture is in the state Reserved.

6. The method according to claim 1, further comprising
deactivating the monitoring of the sensor signal in periods in which no use of the furniture is scheduled.

7. A device for recognition of an occupancy situation of at least one furniture, wherein
the furniture comprises a part on which a user acts when the furniture is used, the device comprising:
a collision sensor that measures a force effect on the furniture when the furniture is occupied, wherein
the device is configured to release the furniture and change a state of the occupancy situation from Occupied to Released when the force effect is below a threshold during an entire predetermined period.

8. The device according to claim 7, wherein a power supply of the device is one of a battery and an accumulator.

9. A furniture system, comprising
at least one furniture having
at least one part which is acted on by a user when the furniture is used, and
at least one collision sensor arranged in the force action chain between the at least one part and the residual furniture for detecting actions of the user, and
a device according to claim 7.

10. The furniture system according to claim 9, wherein the power supply of the furniture system is one of a battery and an accumulator.

11. A Furniture system comprising:
a plurality of furniture each having;
at least one part which is acted on by a user when the furniture is used, and
at least one collision sensor arranged in the force action chain between the at least one part and the residual furniture for detecting actions of the user, and a device according to claim 7.

12. A reservation system comprising
the furniture system according to claim 9,
wherein the reservation system is configured to indicate the occupancy situation of the at least one furniture to the user, and to receive reservations for a requested period.

13. The reservation system according to claim 12, further comprising a guide device configured to guide the user to a vacant furniture.

14. The reservation system according to claim 13, wherein the guide device comprises an optical indicator device or is configured to communicate with an augmented reality glasses.

15. The method according to claim 1, further including prohibiting the releasing of the furniture during pause times of an employee.

16. The method according to claim 15, wherein the prohibiting is not performed when a total pause time exceeds a threshold.
